(19) United States
(12) Patent Application Publication
(10) Pub. No.: US 2018/0184456 A1
(43) Pub. Date: Jun. 28, 2018

(54) AP COORDINATED DYNAMIC SENSITIVITY CONTROL IN 802.11 STATIONS

(71) Applicant: KABUSHIKI KAISHA TOSHIBA, Tokyo (JP)

(72) Inventors: Siva Kupanna SUBRAMANI, Bristol (GB); Fengming CAO, Bristol (GB); Parag Gopal KULKARNI, Bristol (GB); Mahesh SOORIYABANDARA, Bristol (GB)

(73) Assignee: KABUSHIKI KAISHA TOSHIBA, Tokyo (JP)

(21) Appl. No.: 15/507,050

(22) PCT Filed: Mar. 31, 2015
(86) PCT No.: PCT/GB2015/051010

§ 371 Date: Feb. 27, 2017

(51) Int. Cl. H04W 74/08; H04W 24/08; H04W 24/10

(52) U.S. Cl. CPC H04W 74/0816; H04W 84/12; H04W 24/10; H04W 24/08

(57) ABSTRACT

There is provided a method and device for managing a wireless network comprising a wireless access point for communicating over a transmission channel with one or more wireless stations. The method comprises the wireless access point monitoring network performance and, if the network performance is below a limit, issuing an instruction to one of the wireless stations to operate in a mode to more reliably determine when the transmission channel is clear.

### FIELD

Embodiments described herein relate generally to wireless communication methods and devices and more specifically to methods and devices for managing the clear channel assessment (CCA) thresholds for wireless stations.

### BACKGROUND

Wireless Local Area Network (WLAN) technology has significantly matured over the last decade and while it continues to function well, there are scenarios where it struggles to deliver acceptable performance for the most basic services. In particular, in scenarios with highly dense deployments, performance can deteriorate. One of the main causes of this deterioration is the overcrowding of devices in the unlicensed bands where WLANs typically operate.

Generally, wireless networks comprise a wireless access point which allows wireless stations to wirelessly connect to a wired network. A wireless station is a device which has the capability to connect wirelessly to a wireless network, for instance, via the 802.11 wireless protocol.

Increased density increases the likelihood of collision between two wireless transmissions, unless steps are taken to mitigate this likelihood.

One approach to attempt to reduce the possibility of collision is for a station (STA), before using a channel, to sense the channel to determine if the channel is clear to be used. This is often governed by a clear channel assessment (CCA) threshold, a parameter used to define the sensitivity of a station to incoming transmission from other STAs.

The performance of a wireless station can vary depending on its distance from the access point and the CCA threshold it uses. Stations with a higher CCA threshold are more likely to transmit at the same time as another station in the network and therefore cause packet collisions.

Accordingly, in some scenarios some stations (such as those closer to the access point who use aggressive CCA thresholds and are therefore less sensitive to other stations in the network) can dominate communication with the access point to the detriment of stations at the edge of the network. This can not only lead to unfairness between network users but also to an overall drop in throughput across the network. Accordingly, there is a need for a method for managing the access point and/or stations to improve fairness and throughput across the network.

### BRIEF DESCRIPTION OF THE DRAWINGS

The present invention will be understood and appreciated more fully from the following detailed description taken in conjunction with drawings in which:

FIG. 1 shows two wireless networks according to an embodiment;

FIG. 2 shows a station according to an embodiment;

FIG. 3 shows an access point according to an embodiment;

FIG. 4 shows a sequence of messages between a number of stations and an access point according to an embodiment;

FIG. 5 shows a method of managing a wireless station according to an embodiment; and

FIG. 6 shows a method of operating an access point according to an embodiment.

### DETAILED DESCRIPTION

According to one embodiment there is a method for managing a wireless network comprising a wireless access point for communicating over a transmission channel with one or more wireless stations. The method comprises the wireless access point monitoring network performance and, if the network performance is below a limit, issuing an instruction to one of the wireless stations to operate in a mode for more reliably determining when the transmission channel is clear.

The instruction is a signal or alert to the station indicating that it may be negatively affecting network performance, for instance, by causing packet collisions. This may have been caused by an increase in the CCA threshold at the station, resulting in the station being less sensitive and therefore not detecting transmissions from other stations on the network that may now have been pushed out of its hearing range due to the aforementioned change in the CCA threshold. Embodiments of the invention therefore allow a wireless access point to let stations know when their operation may be interfering with other stations on the network.

According to one embodiment, the method comprises issuing, from the wireless station to the access point, a signal indicating a clear channel assessment, hereinafter referred to as CCA, threshold for the wireless station. The CCA threshold may be the current CCA threshold for the station, or may be a CCA threshold which the station wishes to utilise. The station may increase its CCA threshold and subsequently report the increased CCA threshold to the access point. The access point then may make a decision based on the network performance as to whether to instruct the station to take steps to more reliably determine that the transmission channel is clear. In an alternative embodiment, the station issues a request to the access point for permission to increase its CCA threshold. If permission is granted, or no instruction to reduce packet collisions is received, then the station increases its CCA threshold.

According to a further method each station reports its CCA threshold to the access point and the access point issues the instruction to the station in response to determining that the CCA threshold for the station is greater than the average CCA threshold of the network. This allows the access point to ensure that the stations which are more likely to be causing packet collisions (by transmitting when other stations are transmitting) are instructed to more reliably ensure that the transmission channel is clear before transmitting. In an alternative embodiment, the stations are able to increase their CCA threshold and the access point monitors how many times a station has increased its CCA threshold and issues the instruction to the station if it has increased its CCA threshold more than the average number of times across in the network. This allows the access point to curtail the stations which are operating more successfully and therefore have increased their CCA threshold a greater number of times. In one embodiment, the initial CCA threshold and the step size for each increase in the CCA threshold is predefined. Accordingly, the number of times the CCA threshold has been increased is indicative of the current CCA threshold for the respective station.

According to an embodiment, the mode comprises the wireless station limiting its CCA threshold. The instruction therefore ensures that the CCA threshold for the station may not rise above a certain limit in an attempt to ensure that the station is still able to detect stations within the network. In one embodiment, the CCA threshold is reduced from its current value. This may be in response to a recent increase in the CCA threshold and therefore may be a reduction to a prior CCA threshold. In an alternative embodiment, the limit prevents an increase in the CCA threshold, for instance, where the station has requested permission to increase the CCA threshold. In addition, the limit may be a maximum CCA threshold.

According to a further embodiment, the mode comprises the wireless station activating request to send/clear to send (RTS/CTS). This allows a higher CCA threshold to be used as RTS/CTS prevents packet collisions caused by hidden nodes. Accordingly, where the access point has determined that a station may be causing packet collisions, the access point may instruct the station to activate RTS/CTS to ensure that the access point is clear to receive data before transmitting.

According to one embodiment monitoring network performance comprises monitoring the throughput of the network, and the limit is a threshold throughput. The threshold throughput may be a threshold throughput for the whole network. This allows the access point to instruct a station to be more aware of other users on the network when its operation may be causing the overall throughput of the network to deteriorate. In an alternative embodiment, the distribution of throughput of the stations in the network is monitored. Where one or more stations have a throughput which is more than a threshold amount below the average throughput then the access point may issue the instruction to a station with a higher than average CCA threshold. If a plurality of stations have a higher than average CCA threshold then the instruction may be issued to the station of this plurality of stations which has the highest throughput or has the highest received signal strength indicator.

Monitoring network performance may involve monitoring the number and/or rate of packet collisions. Where the number or rate of collisions is greater than a threshold limit then the access point may instruct a station to operate in a mode to more reliably determine when the transmission channel is clear.

The limit may be based on a previous value to account for changes in network performance. This allows a deterioration in network performance to be detected. For instance, where the throughput is being monitored, the limit may be a decrease from the previous value of a specific amount. For instance, where a station has reported an increase in its CCA threshold and the access point has detected a decrease in throughput compared to the throughput before the increase, then it may instruct the station to more reliably determine when the transmission channel is clear. Alternatively, the average throughput may be monitored over a time series or as a moving average and a decrease of more than a threshold amount may trigger the instruction to be issued. As before, the throughput may be an average throughput across the network or the throughput for a specific station. As an alternative to throughput, the number of packet losses or retransmissions may be monitored and an increase may trigger the issue of the instruction.

According to an embodiment, the station monitors the success rate of transmission to the access point and issues a signal indicating an increase in its CCA threshold if the success rate is above a predefined limit. This allows the station to dynamically increase its CCA threshold in the event of strong performance; however, ensures that the access point still keep track of any changes to ensure that they do not negatively affect the network performance. The signal may be a request to increase the CCA threshold. Alternatively, station may increase the CCA threshold if the success rate is above a predefined limit and the signal may be a report indicating that the CCA threshold has been increased. The access point may then make a decision as to whether the station should be allowed to continue with the increased CCA threshold without RTS/CTS.

According to an embodiment, the station monitors the success rate of transmission to the access point and the station decreases its CCA threshold when the success rate drops below a lower limit. This ensures that the station can adapt its CCA threshold if it is experiencing poor performance. By reducing the CCA threshold, the station is more likely to detect transmissions from other stations in the network and therefore avoid packet collision.

In the above embodiments described herein, any signal or instruction between the station and access point could be transmitted in conjunction with payload data (for instance, in the header of the transmitted data) or sent as a separate packet or perhaps, piggybacked on existing signalling messages.

According to an embodiment there is provided a device for managing a wireless network comprising one or more wireless stations, the device comprising a controller configured to monitor network performance and, if the network performance is below a limit, issue an instruction to one of the wireless stations to operate in a mode to more reliably determine when the transmission channel is clear.

According to an embodiment the controller is configured to receive, for each station in the network, a report of the clear channel assessment, hereinafter referred to as CCA, threshold for the station and the instruction is issued to the station in response to determining that the CCA threshold for the station is greater than the average CCA threshold of the network.

According to an embodiment the device may be incorporated into a wireless access point.

According to an embodiment there is provided a device for managing the wireless communication of a wireless station with a wireless access point. The device comprises a controller configured to communicate with the access point over a communication channel and upon instruction from the access point, operate in a mode to more reliably determine when the transmission channel is clear.

In one embodiment, the controller is configured to issue a signal indicating a clear channel assessment, hereinafter referred to as CCA, threshold to the access point.

In a further embodiment, the mode comprises the controller limiting its CCA threshold.

In one embodiment, the mode comprises the controller activating request to send/clear to send.

In one embodiment the controller is configured to define an initial CCA threshold, monitor the success rate of communication between the station and the access point, and when the success rate exceeds a predefined limit, issue a signal indicating an increase in its CCA threshold.

In one embodiment the controller is configured to decrease the CCA threshold when the success rate drops below a lower limit.

In one embodiment the device may be incorporated into a wireless station.

According to one embodiment there is provided a method for managing a wireless station, the wireless station being configured to connect to a wireless access point. The method comprises the station communicating with the access point over a communication channel and, upon instruction from the access point, operating in a mode to more reliably determine when the transmission channel is clear. The specific case of WLAN networks is discussed in this disclosure, although the reader will appreciate that the present disclosure could be adapted to other communications technologies.

In generic terms, the 802.11 standard refers to all the addressable units as “stations” (STA). In an infrastructure setup, the centralised unit which has station functionality but also manages all the distributed stations is referred to as the access point (AP).

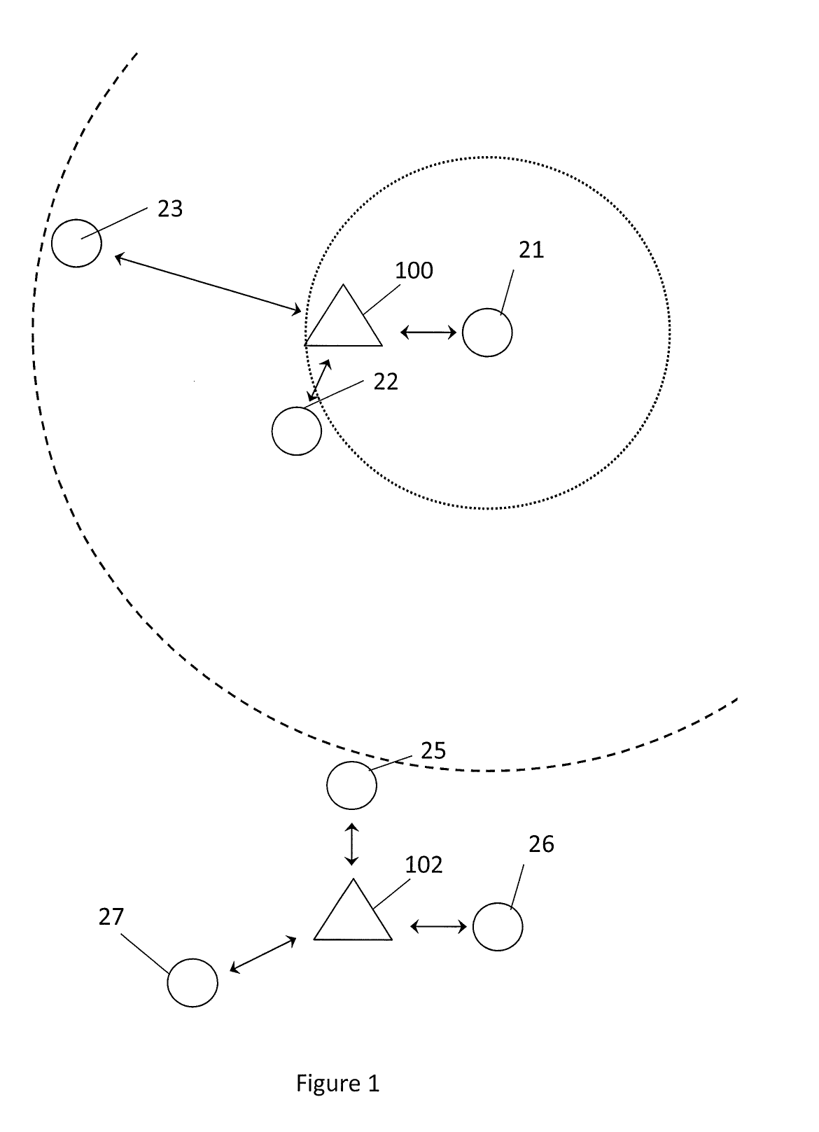

FIG. 1 shows two wireless networks according to an embodiment. The first wireless network comprises an access point (AP) 100, and three stations (STAs) 21, 22, 23. The stations 21, 22, 23 communicate wirelessly with the access point 100 over a wireless channel. The second network comprises three stations 25, 26, 27 communicating wirelessly with a second access point 102.

As multiple stations 21, 22, 23 are present in the first network, there is a chance that two or more stations 21, 22, 23 will attempt to transmit to the access point 100 at the same time thereby causing a packet collision. To avoid this, the stations 21, 22, 23 utilise carrier sense multiple access with collision avoidance (CSMA/CA). This involves clear channel assessment (CCA).

CCA involves monitoring the channel for any transmissions. Each station 21, 22, 23 samples the energy of the channel periodically (for instance, every 4ps). When the station 21, 22, 23 detects electromagnetic waves in the channel which exceed a CCA threshold, then the station 21, 22, 23 detects that the channel is busy. Transmission of any data is deferred until the channel is free, i.e. until the detected energy of the channel is below the CCA threshold.

The CCA threshold effectively dictates the receiver sensitivity of the station 21, 22, 23. Signals below the CCA threshold will effectively not be detected. This is even though the hardware of the receiver may still be capable of detecting weaker signals. Accordingly, increasing the CCA threshold (e.g. from −80 dBm to −60 dBm) effectively decreases the sensitivity of the receiver and will therefore make the station 21, 22, 23 less “sensitive” to signals from other stations 21, 22, 23.

If the CCA level of a station 21, 22, 23 or access point 100 is increased, the threshold used by the station or access point for determining whether or not a channel is ‘free’ from other data traffic, and therefore for deciding whether or not the station or access point 100 can itself transmit is increased. This means that, following such an increase, the station 21, 22, 23 or access point 100 will ignore those signals that may be present in the channel that, before the increase in CCA threshold would have been classified as valid signals (and the detection of which would have, consequently, lead the station 21, 22, 23 or access point 100 to suppress its own transmission activity), but that, following the increase on CCA threshold fall below the new CCA threshold (and, consequently, do no longer inhibit transmission from the station 21, 22, 23 or the access point 100). These signals are simply filtered out. The signals concerned are those that, before the increase in the CCA threshold, had been just above the then valid CCA threshold and are often signals from distant stations 25, 26, 27.

It will be appreciated that adapting CCA thresholding in the above described manner can help to prevent interference between networks in close proximity. In the case of FIG. 1, the first and second networks are located in close proximity. The effective range of detection for station 21 is shown for a first CCA threshold (dashed line) and a second, higher CCA threshold (dotted line). With the first CCA threshold, the station 21 is able to detect signals from all other stations 22, 23 in the first network as well as the access point 100. If the CCA threshold were to be decreased from the first threshold, there is a chance that signals from the second network would be detected, thereby preventing station 21 from transmitting even if access point 100 is free to receive signals.

As station 21 is located close to the access point 100, a strong signal will be received from the access point 100. Accordingly, the CCA threshold may be increased relatively high without interfering with direct communication with the access point 100. If such an increase was implemented, however, data transmission by stations 22, 23 of the network will not be detected any longer by station 21. The likelihood that station 21 initiates data transmission whilst station 22 and/or 23 already transmit data increased as a consequence. This leads to an increase in packet collisions at the access point 100/in the network. This is shown in FIG. 1 as the range for the second CCA threshold (the dotted line) encompasses the access point but not the remaining stations 22, 23 in the network.

CCA threshold is generally set to be relatively conservative/low. It will be appreciated that, by increasing the CCA threshold for station 21, throughput between station 21 and the access point 100 may be increased. Whilst this is of course desirable it does not come without disadvantages. In particular, an increase in data traffic between any station 21, 22, 23 and the access point 100 in the network may inhibit data traffic between the other stations in the network and the access point 100. This may lead to a drop off in throughput for “edge users” (stations located at a distance from the access point 100 in a manner that allows them to just participate in network data traffic), such as station 23. This not only leads to station 21 being treated preferentially over station 23, but can also lead to an overall drop in throughput across the network. Accordingly, there is a need for a method which allows the optimisation of the CCA threshold for stations 21, 22, 23 in a network, particularly to improve fairness between competing stations 21, 22, 23.

CCA effectively avoids packet collision; however, cannot avoid collision in the case of hidden nodes, that is, nodes that participate in network data traffic without, however, being recognised as such by all of the stations in the network. If station 21 used the second CCA threshold (illustrated by the dotted line in FIG. 1), then data traffic generated by stations 22 and 23 would no longer be recognised as such by station 21. In this scenario station 22 and 23 would be hidden nodes.

A further method of avoiding packet collision is virtual carrier sensing using request-to-sent/clear-to-send (RTS/CTS). In RTS/CTS the station 21, 22, 23 requests permission to transmit to the access point 100. The access point 100 then sends a signal indicating when it is free to receive the transmission. This tells the station 21, 22, 23 when the channel is clear even in the case of hidden nodes. RTS/CTS has several advantages, especially in denser network scenarios and wider bandwidth scenarios; however, it incurs additional overhead.

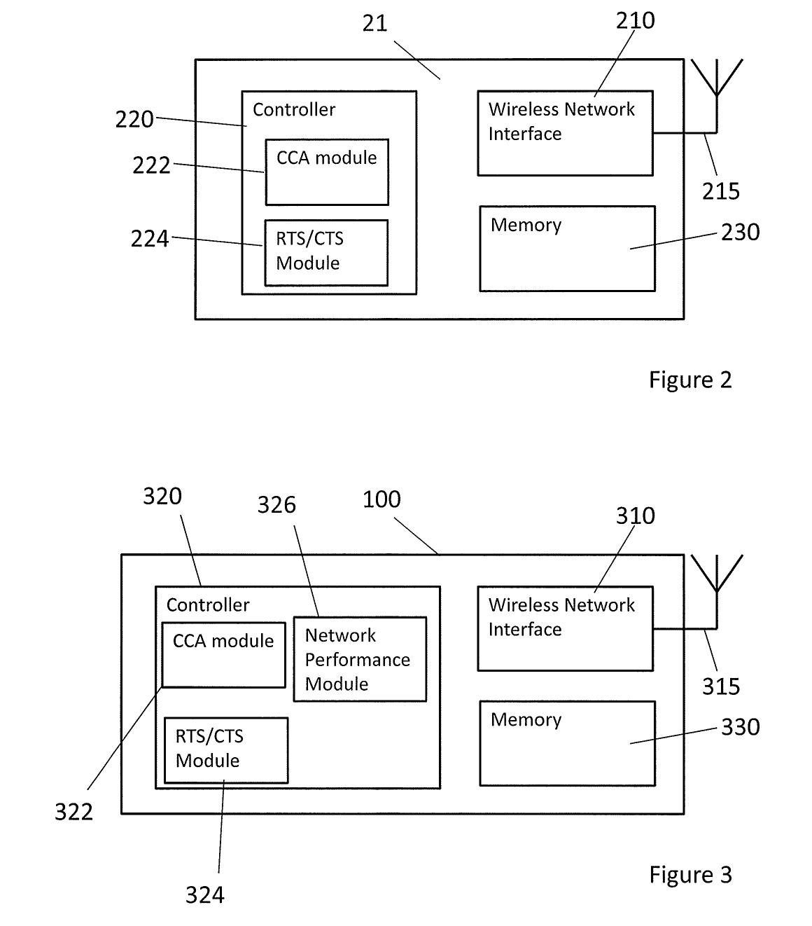

FIG. 2 shows a station 21 in further detail. The station 21 comprises a wireless network interface 210, a controller 220 comprising a clear channel assessment (CCA) module 222 and a request-to-send/clear-to-send (RTS/CTS) module 224 and a memory 230. The wireless network interface 210 is coupled to an antenna 215.

The wireless network interface 210 is operable to send and receive signals using the antenna 215 on one or more of a plurality of radio frequency channels defined in a radiofrequency spectrum. The controller 220 is configured to manage the wireless network interface 210 to send and receive signals according to a communication protocol, for example, to stations or access points as described above in relation to FIG. 1. The controller is in communicative connection with the memory 230. The CCA module 222 determines when the channel is clear to reduce packet collisions at the access point 100 as discussed in relation to FIG. 1. The RTS/CTS module 224 controls the exchange of RTS and CTS packets as described with reference to FIG. 1.

FIG. 3 shows the access point 100 in further detail. The access point 100 comprises a wireless network interface 310, a controller 320 comprising a clear channel assessment (CCA) module 324, a request-to-send/clear-to-send (RTS/CTS) module 324 (as discussed in relation to FIG. 2) and a network performance module 326, and a memory 330. The wireless network interface 310 is coupled to an antenna 315. The access point 100 functions much like the station 21, with the exception of being capable of and configured to manage the network. The network performance module 326 monitors network performance and determines when a station may be negatively affecting network performance.

The methods carried out by the modules of the access point 100 and the stations 21, 22, 23 are described in more detail below. It will be appreciated that these methods are implemented by software or firmware code that may be stored in memories 230 and 330 of station 21 and access point 100 respectively and that, when executed by the respective controllers 220 and 320 (or their respective CCA modules 222 and 322, their respective RTS/CTS modules 224 and 324 or by the network performance module 326) puts the described methods into practice. Any reference to modules that form part of the controllers 220 and 324 is not intended to be limiting and is, instead, intended to be understood as an operation/method put into practice by the controllers 220 and 320 respectively, when executing the corresponding software/firmware instructions.

As mentioned above, in dense network scenarios the stations 21, 22, 23 that are closer to the access point 100 may potentially receive better throughput than the cell edge users. Thus, whilst some stations 21, 22, 23 may benefit from higher throughput, there may be others that are disadvantaged. This could potentially lead to a reduction in the overall throughput at the access point 100 if the stations 21, 22, 23 closer to the access point 100 than other ones of the stations 21, 22, 23 choose a CCA level that is so high that it creates such throughput limitations.

In accordance with an embodiment, a coordination mechanism is employed in which access points 100 are able to deny an increase to the CCA level requested by station(s) 21, 22, 23 that may result in such unfairness or that at least mitigates the effects of such an increase.

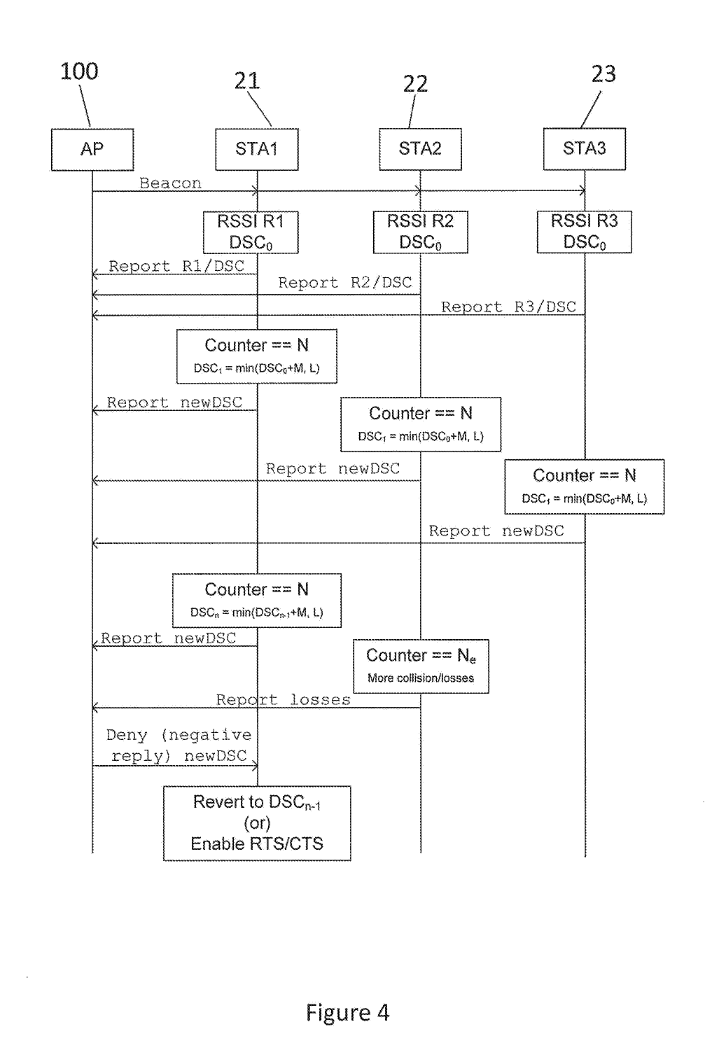

FIG. 4 shows a sequence of messages between stations 21, 22, 23 and the access point 100 according to an embodiment. The access point 100 transmits a beacon signal at regular intervals. Each station 21, 22, 23 receives the beacon signal and, provided the signal strength is above the CCA threshold (and is therefore detectable), calculates a received signal strength indicator (RSSI), R, for the received beacon signal. This provides an indication of the link quality.

Based on the R value, the controller 220 for each station 21, 22, 23 sets an initial transmit power (Pₜ) and modulation coding scheme (MCS) index (used in adaptive modulation and coding). An initial CCA threshold is set. In the present embodiment the initial CCA threshold is −82 dBm; however, alternative initial values may be used. The CCA module 222 is configured to manage the CCA threshold for the station 21, 22, 23 in which it is provided. Each CCA threshold may be represented as a dynamic sensitivity control (DSC) level. DSC₀ is the initial CCA threshold with the subscript 0 denoting “order” of DSC level, i.e. the number of times the CCA level has been increased. In the present application, the terms CCA threshold and DSC level are used interchangeably. In one embodiment, the initial DSC level is:

DSC₀=min(R−M₀, L)

An upper value L is used to ensure that the CCA threshold is not set too high when the station 21, 22, 23 is very close to the access point (i.e. when a very large RSSI is detected). This helps to ensure that stations 21, 22, 23 close to the access point 100 can still detect the remaining stations 21, 22, 23 in the network. The margin, M₀, is subtracted from the CCA level to ensure that stations 21, 22, 23 which are further away than the access point 100 are still detected.

In an alternative embodiment, a default CCA threshold is initially set (for instance, −82 dBm). In this case:

DSC₀=−82 dBm

Subsequent DSC levels are then calculated as discussed below.

Once the initial DSC level (DSC₀) has been set, each station 21, 22, 23 begins packet transmission. Payload data is transmitted along with a report of the initial CCA threshold and the RSSI. Each time the CCA threshold of any of stations 21, 22, 23 is changed, the station 21, 22, 23 implementing the change reports the new CCA level to the access point 100. In one embodiment, the new CCA level in transmitted to the access point 100 in a reporting packet which is separate to the payload data. In an alternative embodiment, the new CCA level is transmitted in conjunction with the payload data. In one embodiment, the CCA level is reported in a header of the data transmission.

If transmitted data packets are successfully received by the access point 100 then the access point 100 transmits an acknowledgement packet (Ack). The controller 220 of each station 21, 22, 23 is configured to count the number of acknowledgements received. When the number of acknowledgements over a predefined number of transmissions reaches a threshold, N, then the controller 220 determines that the transmission quality is sufficiently interference free to justify an increase in the station's 21, 22, 23 CCA threshold. In one embodiment, when the transmission success rate exceeds a predefined limit then the controller 220 determines that the CCA level may be increased. This is because there is likely to be a strong connection between the access point 100 and the station 21, 22, 23 and so the CCA threshold may be increased to make the station 21, 22, 23 implementing the increase even less sensitive to external signals in an attempt to improve throughput. Accordingly, the station 21, 22, 23 that has reached the threshold count of N increases its DSC level.

When the station 21, 22, 23 increases its DSC level, an increment of M is added to the CCA threshold. An upper value L is used to ensure that the CCA threshold is not set too high when the station 21, 22, 23 is very close to the access point (i.e. when a very large RSSI is detected). The increment M is added to the current DSC level and compared with the limit L. The smaller of the two is chosen. This helps to ensure that stations 21, 22, 23 close to the access point 100 can still detect the remaining stations 21, 22, 23 in the network. Accordingly, for the n^{th} increase in the CCA threshold, the new DSC level (DSCₙ) is:

DSC₀=min(DSCₙ₋₁+M, L)

where DSCₙ₋₁ is the CCA threshold before the DSC level is increased. Alternative increment values and upper values may be utilised based on the requirements of the network. In one embodiment, the increment M varies with the DSC level, so that a larger increment may be added at lower CCA thresholds to quickly increase the DSC level, but smaller increments are added at higher DSC levels to allow the CCA threshold to be fine-tuned.

The new CCA threshold is reported to the access point 100 as discussed above, along with the new DSC order (the number of times the CCA level has been increased). The stations 21, 22, 23 also report their current throughput performance to the access point 100. The access point 100 monitors the performance of the network and determines whether the new CCA threshold is allowable. If the new CCA level is determined to be unfair (for example because following the increase in the CCA threshold of one station the throughput another station is able to produce is found to be reduced to a level that is deemed insufficient), then the access point 100 sends a denial signal to the station to deny permission for the increased DSC level. The signal instructs the station to operate in a mode to more reliably (than is presently the case) determine when the transmission channel is clear. In response to this instruction, the station 21, 22, 23 may revert back to its previous CCA level or activate RTS/CTS (via the RTS/CTS module 224) and keep the increased CCA level. It will be appreciated that this denial may either be sent to the station 21, 22, 23 after the station has increased its CCA threshold (say, for example, once a deterioration of network traffic/throughput has been detected, wherein this deterioration can reasonably be suspected to be caused by the increase in CCA threshold of the station) or following a request for a permissions to increase the CCA threshold sent by the station 21, 22, 23 and received at the access point 100.

As mentioned above, aggressive increases in the CCA level for selective stations 21, 22, 23 may result in a reduction in the throughput of the access point 100. If the access point 100 detects a drop in the overall throughput of the network after the DSC level of a station has been increased then it sends the signal to the station 21, 22, 23 to instruct the station to more reliably determine when the transmission channel is clear. The station 21, 22, 23 therefore reverts to the CCA threshold used prior to the most recent increase in DSC level and/or activated RTS/CTS to attempt to reduce the number of packet collisions. The instruction is effectively a denial of permission for unrestricted use of the higher CCA threshold.

In addition, or alternatively, the access point 100 may issue the instruction to more reliably determine whether the transmission channel is clear if one or more of the stations 21, 22, 23 in the network experiences poor performance. If one of the stations 21, 22, 23 has a throughput below a predefined threshold whilst the overall throughput is above a network threshold, then this may indicate that one or more of the remaining stations 21, 22, 23 in the network may have set their CCA thresholds too high. Accordingly, when one of the stations 21, 22, 23 next increases their CCA threshold, the access point 100 issues a signal denying unrestricted use of the higher CCA threshold. In alternative embodiments, thresholds for the number or rate of losses and/or the transmission success rate are used as indicators of network performance.

In a further embodiment, the access point 100 monitors network performance by storing performance metrics. This may be on a per station or per cell basis. The performance metrics are averages over a specific window, e.g. a period of time or a number of packets. The performance metrics may be average throughput, loss, retransmissions or any other indicator of average performance over the window. When the average performance falls in comparison to previous performance, then the access point 100 issues an instruction to one of the stations 21, 22, 23 to more reliably determine whether the transmission channel is clear. When retransmissions or losses are monitored, a fall in performance is indicated by an increase in retransmissions or losses.

Alternatively, if a station 21, 22, 23 is experiencing poor performance, such as low throughput or increased packet collision, the station 21, 22, 23 may flag this poor performance to the access point 100 which can then make a decision as to whether to curtail some future DSC level increases or to send a signal or signals to one or more of the remaining stations 21, 22, 23 in the network to more reliably determine when the transmission channel is clear. This is shown in FIG. 4 wherein station 22 reports an increase in the number of collisions to the access point 100. In light of this reduction in performance, the access point 100 instructs station 21 to revert to its previous DSC level or activate RTS/CTS to reduce the number of packet collisions.

The increase in collisions in FIG. 4 is represented by the acknowledgement counter not reaching the predefined threshold N. In an alternative embodiment, the stations 21, 22, 23 maintain a separate error counter and report poor performance when the number of errors reaches a threshold.

The access point 100 need not curtail increases in DSC level in response to all reports of poor performance. It may make a decision as to whether the poor performance is due an unfair distribution of DSC levels across the network. In one embodiment, the access point 100 decides whether to issue an instruction to operate in a more sensitive mode based on the DSC level of the station 21, 22, 23 reporting poor performance. If the DSC level of the station 21, 22, 23 is below a limit then the access point 100 determines to issue an instruction to one of the stations 21, 22, 23 to operate in a mode for more reliably determining when the transmission channel is clear. In one embodiment, this limit is a predefined DSC level or order. In an alternative embodiment, this limit is dependent on the DSC levels of the remaining stations in the network 21, 22, 23.

The access point 100 need not issue the instruction to the very next station 21, 22, 23 which increases its DSC level or proposes to do so, or indeed to the last station 21, 22, 23 to have increased its DSC level. In one embodiment, the access point 100 is configured to consider the order of the DSC levels. As mentioned above, the order of the DSC level is the number of increments above the initial DSC level a given station is operating at. Accordingly, the order of DSC₄ is four. If a station 21, 22, 23 reports a higher than average DSC order, then the access point 100 may choose to issue the instruction to this station 21, 22, 23. In one embodiment, the access point 100 prioritises issuing instructions to stations 21, 22, 23 who have a higher than average DSC order, that is, who have added more than the average number of increments to their CCA threshold. Naturally, when a station 21, 22, 23 decreases its DSC level, it also decreases its DSC order.

In an alternative embodiment, instead of considering the DSC order, the access point 100 issues an instruction to more reliably check whether the transmission channel is clear if the station has a higher than average CCA threshold. Having said this, it is advantageous to consider DSC order as a station 21, 22, 23 which receives a strong RSSI may set it's a high initial CCA threshold but experience poor performance and therefore not increase its CCA threshold (i.e. have a DSC order of zero). DSC order is therefore a good indicator of how well a station 21, 22, 23 is performing.

In the above embodiment, the CCA level is increased and then reverted back to its previous level (or RTS/CTS is activated) when a signal indicating poor network performance is received from the access point 100. In an alternative embodiment, the station 21, 22, 23 which determines that a higher CCA threshold is desired sends a signal to the access point 100 to request permission to increase its CCA threshold. If permission is granted then the station 21, 22, 23 increases its CCA threshold. Given that not all access points 100 will be configured to manage the CCA thresholds of stations 21, 22, 23 in their network, the station 21, 22, 23 waits for a predetermined period of time and, if no denial is received, then the CCA threshold is increased.

As discussed briefly above, a station 21, 22, 23, upon receipt of a denial, has two options. It can decrease its CCA threshold or it can maintain the higher CCA threshold and activate RTS/CTS via the RTS/CTS module 224. By activating RTS/CTS, the station 21, 22, 23 avoids the problem of hidden nodes; however, overhead is increased. By reverting back to the previous CCA threshold, the station 21, 22, 23 goes back to monitoring a wider interference range and therefore reduces the possibility of hidden nodes by enabling the station 21, 22, 23 to listen to a wider set of stations 21, 22, 23. Both methods improve fairness across the network.

Embodiments of the present invention adaptively set CCA level at stations 21, 22, 23 by coordinating with the access point 100 to ensure fairness across the network. The access point 100 monitors the throughput performance of the network and the throughput of each station 21, 22, 23 individually and, if the performance is significantly affected by an increase in CCA threshold by one of the stations 21, 22, 23, the access point sends a signal to stations 21, 22, 23 operating with higher order DSC levels to reduce their CCA threshold or activate RTS/CTS. In addition to improving fairness across the network, the present embodiments improve overall access point 100 throughput by optimising the CCA thresholds for each station 21, 22, 23.

The individual performance of the access point 100 and the stations 21, 22, 23 will now be described.

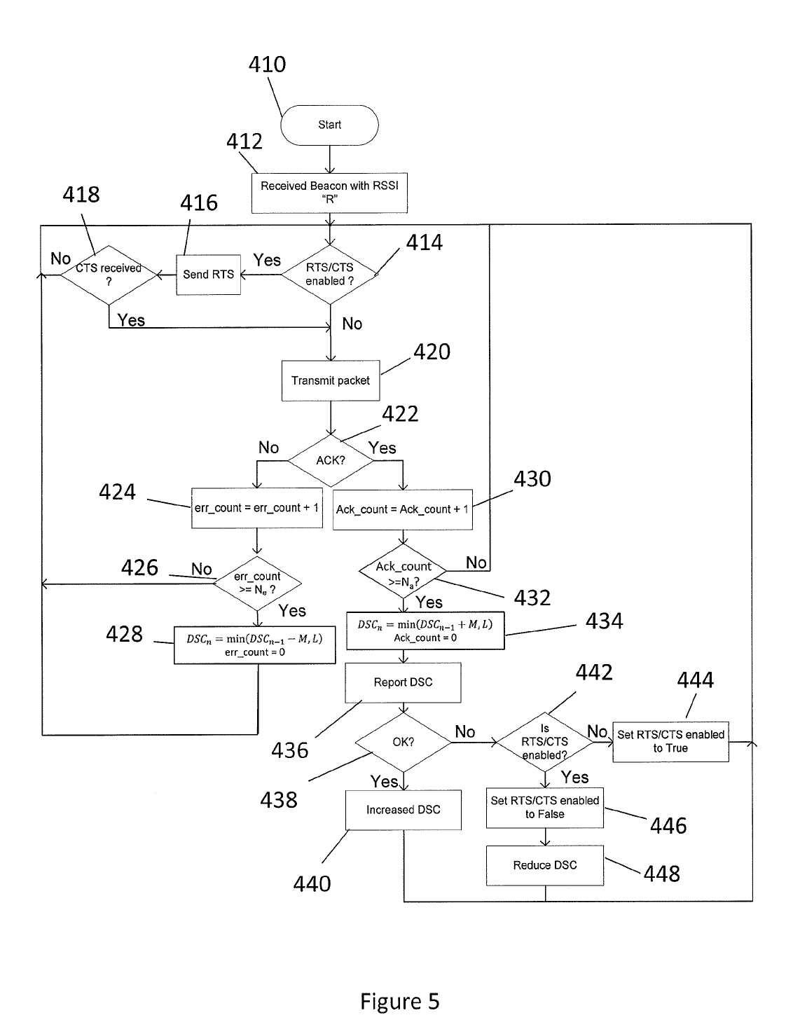

FIG. 5 shows a method of managing a wireless station according to an embodiment. The station starts 410 by monitoring the channel for a beacon from the access point. When a beacon is received 412 the RSSI is calculated thereby allowing the transmit power, the MCS index and the initial CCA threshold to be set as discussed above with regard to FIG. 4.

The station then determines whether RTS/CTS is enabled 414. If RTS/CTS 414 is not enabled the station transmits payload data to the access point 420 if no signal above a CCA threshold currently set for the station is detected in the channel. If RTS/CTS is enabled, then an RTS packet is transmitted to the access point 416. The station then checks whether a CTS packet is received 418. If a CTS packet is not received then the method loops back to step 414 to check whether RTS/CTS is still enabled. If a CTS packet is received then the station transmits the data packet including the payload 420.

Once the data packet has been transmitted 420, the station checks for an acknowledgement of receipt (Ack) from the access point 422. If an acknowledgement is not received, then an error count is increased 424. The station then checks to see if the error count is greater than or equal to a predefined threshold Nₑ 426. The predefined threshold may be a threshold rate or a threshold number of errors. If the predefined threshold is not reached then the station loops back to step 414 to check whether RTS/CTS is still enabled. If the predefined threshold is reached or exceeded, then the CCA level is reduced by one step, M, and the error counter is reset 428. The new DSC level (DSCₙ) is then:

DSCₙ=min(DSCₙ₋₁−M, L)

where DSCₙ₋₁ is the previous DSC level. The station then loops back to step 414 to check whether RTS/CTS is activated and subsequently transmit more data to the access point.

If a data packet is transmitted successfully an acknowledgement will be received from the access point. In this case, the acknowledgement count (Ack_count) will be increased 430. The station will then check if the acknowledgement count is greater than or equal to a predefined threshold Nₐ 432. In the present embodiment, the threshold for the acknowledgement count is equal to the threshold for the error count; however, in an alternative embodiment these thresholds differ.

If the acknowledgement count is below the predefined threshold Nₐ then the station loops back to step 414 to check whether RTS/CTS is activated and subsequently transmit more data to the access point. The predefined threshold may be a threshold rate or a threshold number of received acknowledgements. If the acknowledgement count reaches the threshold then the DSC level is increased 434 and the acknowledgement counter is reset. The new DSC level is then:

DSCₙ=min(DSCₙ₋₁+M, L)

The increased DSC level is reported to the access point 436. The station then determines if permission is granted for unrestricted use of the higher DSC level 438. If a denial of permission is not received (or if a signal indicating that permission is granted is received) then the station continues to utilise the higher DSC level 440.

If permission is denied then the station will receive an instruction to operate in a mode to more reliably determine when the transmission channel is clear. If this instruction is received then the station checks whether RTS/CTS is enabled 442. If RTS/CTS is not enabled then the station enables the RTS/CTS and then continues to utilise the higher DSC level 444. If RTS/CTS is enabled then RTS/CTS is disabled 446 and the DSC level is reverted back to its previous level 448. Once a decision on the DSC level has been made by the access point and by the station, the method loops back to step 414 to check whether RTS/CTS is enabled and continue to transmit packets 420.

This method allows the station to dynamically vary its CCA threshold to optimise its performance; however, ensures that no station may increase its CCA threshold too much to the detriment of other users on the network.

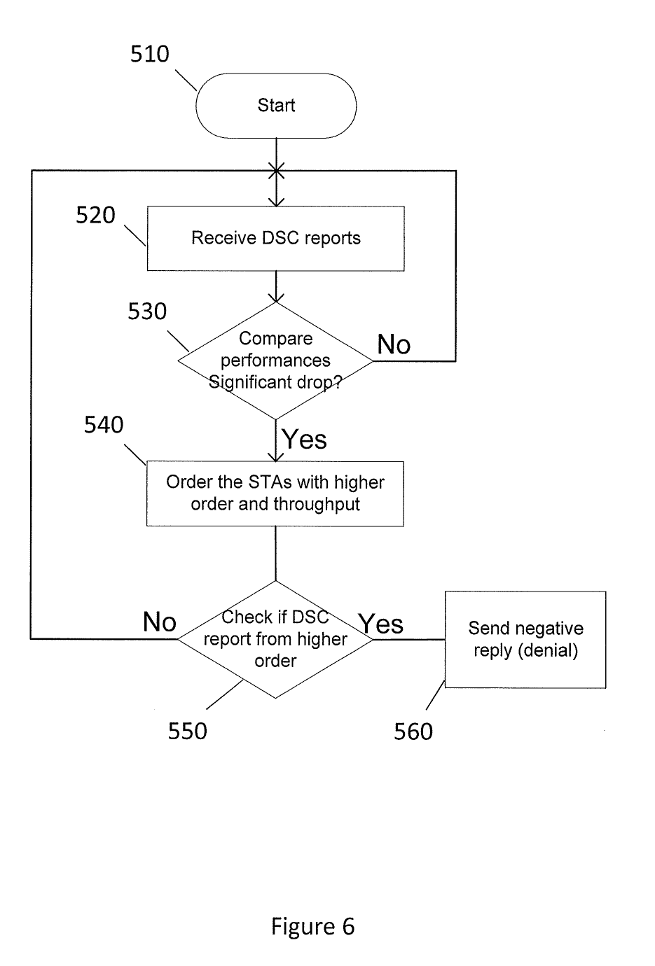

FIG. 6 shows a method of operating an access point according to an embodiment. The access point starts 510 by waiting for the receipt of a DSC report. A DSC report may be received in response to a station setting an initial DSC level based on the beacon, or due to a change in DSC level. The access point monitors the network performance. When a DSC report is received 520 from a station in the network the access point compares 530 the network performance before an increase in DSC level and after an increase in DSC level.

If the network performance does not drop more than a predefined amount then the access point waits to receive more DSC reports 520. If the network performance drops by more than a predefined amount then the access point determines which stations have a higher than average DSC order and throughput 540. This is achieved by ordering the stations in order of DSC and throughput. If a DSC report stating an increase in DSC level is received from a station with a relatively high (e.g. higher than average) DSC level then a signal is sent to the station to deny use of the increased DSC level without RTS/CTS being enabled 560. It is then up to the station whether to revert to its previous DSC level or to activate RTS/CTS. If the DSC report is not from a higher order station then the access point waits to receive further DSC reports 520.

In an alternative embodiment, the retransmission rate of each station is compared and acceptance or denial of a request from a station to increase its DSC level is based on the station's retransmission rate. If it has a lower than average retransmission rate then the request is denied. A lower DSC order station with higher retransmission rate indicates unfairness. Accordingly, in this embodiment, any higher DSC order station's request for increasing DSC level would be denied

Accordingly, the access point monitors network performance and denies unrestricted increases in CCA level where such increases negatively affect network performance. As stated above, a drop in network performance may be represented by a reduction in the throughput of the network or by an increase in packet collisions or retransmissions. A drop in network performance may be represented by one or more stations performing less well than a number of other stations. The access point may monitor the relative performance of the stations and where the throughput or error rate of a station is greater than a predefined amount below the average throughput or error rate then denials may be sent to the stations. Further network performance indicators may be used provided that the access point instructs stations to operate more conservatively when network performance suffers.

Whilst in the above embodiments the station 21, 22, 23 chooses whether to decrease its CCA level or activate RTS/CTS upon receipt of a denial from the access point 100, in an alternative embodiment, the access point 100 instructs one of these two options when issuing the denial.

Furthermore, whilst some embodiments increase the CCA threshold before reverting back to the previous CCA threshold (or activating RTS/CTS) when a denial is received, the station 21, 22, 23 may alternatively wait to see if a denial is received and then increase the CCA threshold if no such denial is received or permission is granted.

The present application discusses stations 21, 22, 23 “reporting” their increased DSC levels and the access point “denying” permission for improved CCA thresholds. The reports may alternatively be considered to be requests for permission to continue use of the higher CCA threshold (or permission to increase the CCA threshold). Accordingly, the requests or reports can be considered to be any signal which indicates that a higher CCA threshold is desired by the station 21, 22, 23. Moreover, the denial may be any signal which indicates that continued, unrestricted use of the higher CCA threshold is not permitted or, more generally, that the increase in CCA threshold is likely to negatively affect network performance. The denial is an instruction to the station 21, 22, 23 to operate in a mode to more reliably determine when the transmission channel is clear.

In addition, whilst in the above embodiments the increment added to the CCA threshold when the DSC level is increased during periods of good performance is the same as the increment subtracted from the CCA threshold when the DSC level is decreased, these increments may differ, for instance, to allow a station 21, 22, 23 to step down CCA threshold more quickly than it steps up CCA threshold.

According to any and all embodiments explained above a fairer and more efficient wireless network can be achieved. While certain embodiments have been described, these embodiments have been presented by way of example only, and are not intended to limit the scope of the inventions. Indeed, the novel methods and devices described herein may be embodied in a variety of other forms; furthermore, various omissions, substitutions and changes in the form of the methods and devices described herein may be made without departing from the spirit of the inventions.

The accompanying claims and their equivalents are intended to cover such forms or modifications as would fall within the scope and spirit of the inventions.

1. A method for managing a wireless network comprising a wireless access point (100) for communicating over a transmission channel with one or more wireless stations (21, 22, 23, 24), the method comprising the wireless access point (100):
monitoring network performance: and
if the network performance is below a limit, issuing an instruction to one of the wireless stations (21) to operate in a mode for more reliably determining when the transmission channel is clear.

2. A method according to claim 1 comprising issuing, from the wireless station (21) to the access point (100), a signal indicating a clear channel assessment, hereinafter referred to as CCA, threshold for the wireless station (21).

3. A method according to claim 2 wherein each station (21, 22, 23, 24) reports its CCA threshold to the access point (100) and the access point (100) issues the instruction to the station (21) in response to determining that the CGA threshold for the station (21) is greater than the average CCA threshold of the network.

4. A method according to claim 1 wherein the mode comprises the wireless station (21) limiting its CCA threshold.

5. A method according to claim 1 wherein the mode comprises the wireless station (21) activating request to send/clear to send.

6. A method according to claim 1 further comprising the station (21) monitoring the success rate of transmission to the access point (100) and wherein the station (21) issues a signal indicating an increase in its CCA threshold if the success rate is above a predefined limit.

7. A method according to claim 1 comprising the station (21) monitoring the success rate of transmission to the access point (100) and wherein the station (21) decreases its CCA threshold when the success rate drops below a lower limit

8. A device for managing a wireless network comprising one or more wireless stations (21, 22, 23, 24), the device comprising a controller (320) configured to:
monitor network performance; and
if the network performance is below a limit, issue an instruction to one of the wireless stations (21) to operate in a mode to more reliably determine when the transmission channel is clear.

9. A device according to claim 8 wherein:
the controller (320) is configured to receive a report of the clear channel assessment, hereinafter referred to as CCA, threshold for stations in the network (21, 22, 23, 24); and
wherein the instruction is issued to the station (21) in response to determining that the CCA threshold for the station (21) is greater than the average CCA threshold of the network.

10. A wireless access point comprising a device according to claim 8.

11. A device for managing the wireless communication of a wireless station (21) with a wireless access point (100), the device comprising a controller (220) configured to:
communicate with the access point (100) over a communication channel; and
upon instruction from the access point (100), operate in a mode that allows more reliably determining when the transmission channel is clear.

12. A device according to claim 11 wherein the controller (220) is configured to issue a signal indicating a clear channel assessment, hereinafter referred to as CCA, threshold to the access point (100).

13. A device according to claim 11 wherein the mode comprises the controller (220) limiting its CCA threshold.

14. A device according to claim 11 wherein the mode comprises the controller (220) activating request to send/clear to send.

15. A device according to claim 11 wherein the controller (220) is configured to:
define an initial clear channel assessment, hereinafter referred to as CCA, threshold;
monitor the success rate of communication between the station (21) and the access point (100); and
when the success rate exceeds a predefined limit, issue to the access point (100) a signal indicating an increase in its CCA threshold.

16. A device according to claim 11 wherein the controller (220) is configured to decrease the CCA threshold when the success rate drops below a lower limit.

17. A wireless station incorporating a device according to claim 11.

18. A method for managing a wireless station (21), the wireless station being configured to connect to a wireless access point (100), the method comprising the station (21):
communicating with the access point (100) over a communication channel; and
upon instruction from the access point (100), operating in a mode to more reliably determine when the transmission channel is clear.
